(19) United States
(12) Patent Application Publication
(10) Pub. No.: US 2009/0175160 A1
(43) Pub. Date: Jul. 9, 2009

(54) Precoder Matrix for Multichannel Transmission

(75) Inventors: Sassan Iraji, Helsinki (FI); Ari Hottinen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 11/922,436

(22) PCT Filed: Jun. 28, 2005
(86) PCT No.: PCT/IB2005/001856

§ 371 Date: Feb. 2, 2009

(51) Int. Cl. H04J 11/00

(52) U.S. Cl. 370/208

(57) ABSTRACT

This invention describes a method for precoding in a transmitter utilizing a multichannel transmission, using a precoder for, e.g., M-QAM (M>4) modulated OFDM systems. The invention describes a new precoding method that is suitable for use, e.g., in an MB-OFDM UWB system especially when targeting for high data rates (above 480 Mbps). This may involve transmitting 16-QAM in place of 4-QAM symbols. The method could be adopted also for some future wireless LANs (local area networks), for future evolutions of 3G and for 4G systems.

### TECHNICAL FIELD

This invention is related to multichannel communications, and more specifically to precoding in a transmitter utilizing a multichannel transmission.

### BACKGROUND ART

Block transmission using OFDM or CDMA (code division multiple access) waveforms have become popular in current systems and actively considered for future UWB systems. ODFM is used, e.g., in DVB-T (digital video broadcasting-terrestrial) and WiFi (wireless fidelity) and it has been considered also for 4G wireless systems. Multicode CDMA transmission is used in 3G (WCDMA and CDMA02000) systems. Both of these systems have advantages and drawbacks.

In the OFDM, a single high-speed data stream is transmitted over a number of lower rate subcarriers which makes the system robust against multipath fading and intersymbol interference, because the symbol duration increases for the lower-rate parallel subcarriers. However, the price paid is the loss of multipath diversity due to the fact that each symbol is transmitted over a single flat sub-channel that may undergo deep fading. Therefore, this degrades the performance of an OFDM system.

Furthermore, OFDM has high PAR (peak-to-average ratio) and the performance saturates whenever the outer coding rate is high (e.g., above ¾). However, an OFDM receiver is very simple and can be optimally detected by an FFT transform (assuming that cyclic prefix or zero padding are used and channels are perfectly estimated). On the other hand, the CDMA distributes symbol energy over multiple frequency bins and therefore has better performance than OFDM provided that a proper receiver is used.

The performance of the OFDM system may improve by using the Group Linear Constellation Precoding (GLCP) scheme introduced by Z. Liu, Y. Xin and G. B. Giannakis, in “Linear Constellation Precoding for OFDM with Maximum Multipath Diversity and Coding Gains”, IEEE Trans. on Communications, vol. 51, No. 3, pp. 416-427, March 2003 (referred here as Liu et al.), where they exploit a correlation structure of the OFDM sub-channels and perform optimal subcarrier grouping that splits the set of correlated sub-channels into subsets of less correlated sub-channels. Within each subset of subcarriers, a linear constellation precoder (complex and which can possibly be nonunitary) is designed to maximize both diversity and coding gains. Liu et al. claim that their GLCP design applies to any K (number of groups), with modulations QAM (quadrature amplitude modulation), PAM (pulse amplitude modulation), BPSK (binary frequency shift keying), and QPSK (quaternary frequency shift keying). Their 2×2 (i.e., K=2) and 4×4 (i.e., K=4) precoding matrices have the Vandermonde form as follows:

$$\begin{matrix}P = \frac{1}{α} [ \begin{matrix}1 & {e}^{- j \frac{π}{4}} \\ 1 & {e}^{- j \frac{5 π}{4}}\end{matrix} ] , \\ and & ( 1 ) \\ P = \frac{1}{α} [ \begin{matrix}1 & {e}^{- j \frac{π}{8}} & {( {e}^{- j \frac{π}{8}} )}^{2} & {( {e}^{- j \frac{π}{8}} )}^{3} \\ 1 & {e}^{- j \frac{5 π}{8}} & {( {e}^{- j \frac{5 π}{8}} )}^{2} & {( {e}^{- j \frac{5 π}{8}} )}^{3} \\ 1 & {e}^{- j \frac{9 π}{8}} & {( {e}^{- j \frac{9 π}{8}} )}^{2} & {( {e}^{- j \frac{9 π}{8}} )}^{3} \\ 1 & {e}^{- j \frac{13 π}{8}} & {( {e}^{- j \frac{13 π}{8}} )}^{2} & {( {e}^{- j \frac{13 π}{8}} )}^{3}\end{matrix} ] , & ( 2 )\end{matrix}$$

respectively, wherein α is a normalization factor.

Precoding schemes have been extensively studied in the literature (e.g., see A. Hottinen and O. Tirkkonen, “Precoder Designs for High Rate Space-Time Block Codes,” Conference on Information Sciences and Systems, Princeton University, March 17-19 Jun. 2004, and references therein, for using a precoding scheme with multi-antenna transmission techniques, and X. Giraud, E. Boutillon, and J. C. Belfiore, “Algebraic Tools to Build Modulation Schemes for Fading Channels” IEEE Trans. on Information Theory, vol. 43, No. 3, pp. 938-952, May 1997). One simple precoding matrix which has been adopted in the specification of the physical layer of a Multiband OFDM (MB-OFDM) Ultrawideband (UWB) system is described by

$$P = \frac{1}{α} [ \begin{matrix}1 & 2 \\ 2 & - 1\end{matrix} ] . \qquad ( 3 )$$

Given an input vector with QPSK constellations, with the precoding matrix given by Equation (3), the output constellations are 16-QAM.

The current MB-OFDM UWB provides mandatory data payload rates 53.3, 106.7, and 200 Mbps and non-mandatory rates 80, 160, 320, 400, and 480 Mbps. For rates 320 Mbps and higher, the information bits are mapped into a multi-dimensional constellation using a Dual-Carrier Modulation (DCM) technique. This is exactly the same thing explained above using preceding matrix in (3). The result of using the DCM technique is the expanded constellation sets, 16-QAM, without any Gray mapping. One way to increase the data rate of the current MB-OFDM UWB system is to use a higher order modulation such as 16-QAM. Advanced coding schemes such as LDPC (low density parity check) or Zigzag codings can be used to improve the performance of the higher-order modulated MB-OFDM UWB.

### DISCLOSURE OF THE INVENTION

The objective of the present invention is to provide a precoding method in a transmitter utilizing a multichannel transmission, e.g., in an M-QAM (M>4) modulated MB-OFDM system.

According to a first aspect of the invention, a method for linearly preceding a data stream in a transmitter utilizing a multichannel transmission, comprises the steps of: providing the data stream to a precoder of the transmitter; and performing the precoding of the data stream by the precoder, wherein the precoder is described by a preceding matrix W=U [symbol] I, wherein U is a k×n matrix given by

$$U = [ \begin{matrix}{a}_{11} & {a}_{12} & … & {a}_{1 k} \\ {a}_{11} & {a}_{22} & … & {a}_{2 k} \\ ⋮ & ⋮ & ⋮ & ⋮ \\ {a}_{n 1} & {a}_{n 2} & … & {a}_{nk}\end{matrix} ] , \qquad ( C1 )$$

or U is a further matrix generated by permuting rows or columns of the matrix given by Equation C1 or by multiplying the rows or the columns of the matrix given by Equation C1 by non-zero real or complex numbers, wherein k and n are larger than 2, each element of all elements a₁₁, a₁₂, . . . , aₙₖ of the matrix U is a real or a complex number, [symbol] is a Kronecker product, and I is an m×m identity matrix with m≧1, wherein at least two of the elements a₁₁, a₁₂, . . . , aₙₖ or at least two of elements of the further matrix have different amplitudes, and U and the further matrix are not Vandermonde matrices.

According further to the first aspect of the invention, n may be equal to k and the matrix U may be a square matrix.

Further according to the first aspect of the invention, m may be equal and then W=U.

Still further according to the first aspect of the invention, k and n may be equal to 4 and matrix U may be given by Equations 6, 7, 8 or 9 as described below.

According yet further to the first aspect of the invention, the data stream may be generated by mapping information bits of an incoming data stream using a multidimensional constellation with one waveform or using the multidimensional constellation in combination with multiple orthogonal waveforms. Still further, the orthogonal waveforms may be defined using a predetermined criterion for Inverse Fast Fourier Transform (IFFT) matrix columns, different time instances, different orthogonal spreading codes or different wavelets.

According still further to the first aspect of the invention, the data stream may be generated by mapping M constellation points using a quadrature amplitude modulation (QAM) format, wherein M>4. Further, a constellation point of the data stream may be generated by mapping log₂M information bits of an incoming data stream.

According further still to the first aspect of the invention, the multichannel transmission may be supported by an orthogonal frequency-division multiplexing (OFDM) system. Further, m may be equal to a size of an Inverse Fast Fourier Transform (IFFT) divided by k.

According to a second aspect of the invention, a computer program product comprises: a computer readable storage structure embodying computer program code thereon for execution by a computer processor with the computer program code characterized in that it includes instructions for performing the steps of the first aspect of the invention indicated as being performed by any component or a combination of components of the transmitter.

According to a third aspect of the invention, a transmitter utilizing a multichannel transmission, comprises: a mapping block, for providing a data stream; and a linear precoder, for performing precoding of the data stream, wherein the precoder is described by a precoding matrix W=U [symbol] I, wherein U is a k×n matrix given by

$$U = [ \begin{matrix}{a}_{11} & {a}_{12} & … & {a}_{1 k} \\ {a}_{11} & {a}_{22} & … & {a}_{2 k} \\ ⋮ & ⋮ & ⋮ & ⋮ \\ {a}_{n 1} & {a}_{n 2} & … & {a}_{nk}\end{matrix} ] , \qquad ( C1 )$$

or U is a further matrix generated by permuting rows or columns of the matrix given by Equation C1 or y multiplying the rows or the columns of the matrix given by Equation C1 by non-zero real or complex numbers, wherein k and n are larger than 2, each element of all elements a₁₁, a₁₂, . . . , aₙₖ of the matrix U is a real or a complex number, [symbol] is a Kronecker product, and I is an m×m identity matrix with m≧1, wherein at least two of the elements a₁₁, a₁₂, . . . , aₙₖ or at least two of elements of the further matrix have different amplitudes, and U and the further matrix are not Vandermonde matrices.

According further to the third aspect of the invention, n may be equal to k and the matrix U may be a square matrix.

Further according to the third aspect of the invention, m may be equal and then W=U.

Still further according to the third aspect of the invention, k and n may be equal to 4 and matrix U may be given by Equations 6, 7, 8 or 9 as described below.

According yet further to the third aspect of the invention, the data stream may be generated by mapping information bits of an incoming data stream using a multidimensional constellation with one waveform or using the multidimensional constellation in combination with multiple orthogonal waveforms. Still further, the orthogonal waveforms may be defined using a predetermined criterion for Inverse Fast Fourier Transform (IFFT) matrix columns, different time instances, different orthogonal spreading codes or different wavelets.

According still further to the third aspect of the invention, the data stream may be generated by mapping M constellation points using a quadrature amplitude modulation (QAM) format, wherein M>4. Further, a constellation point of the data stream may be generated by mapping log₂M information bits of an incoming data stream.

According further still to the third aspect of the invention, the multichannel transmission may be supported by an orthogonal frequency-division multiplexing (OFDM) system. Further, m may be equal to a size of an Inverse Fast Fourier Transform (IFFT) divided by k.

According to a fourth aspect of the invention, a system utilizing a multichannel transmission, comprises: a transmitter, for providing a multipath signal; and a receiver, responsive to the multipath signal, for generating an estimated data signal, wherein the transmitter contains a linear precoder, for performing preceding of data stream, wherein the precoder is described by a precoding matrix W=U [symbol] I, wherein U is a k×n matrix given by

$$U = [ \begin{matrix}{a}_{11} & {a}_{12} & … & {a}_{1 k} \\ {a}_{11} & {a}_{22} & … & {a}_{2 k} \\ ⋮ & ⋮ & ⋮ & ⋮ \\ {a}_{n 1} & {a}_{n 2} & … & {a}_{nk}\end{matrix} ] , \qquad ( C1 )$$

or U is a further matrix generated by permuting rows or columns of the matrix given by Equation C1 or by multiplying the rows or the columns of the matrix given by Equation C1 by non-zero real or complex numbers, wherein k and n are larger than 2, each element of all elements a₁₁, a₁₂, . . . , aₙₖ of the matrix U is a real or a complex number, [symbol] is a Kronecker product, and I is an m×m identity matrix with m≧1, wherein at least two of the elements a₁₁, a₁₂, . . . , aₙₖ or at least two of elements of the further matrix have different amplitudes, and U and the further matrix are not Vandermonde matrices, wherein the precoded data stream is further used for generating the multipath signal by the transmitter.

According further to the fourth aspect of the invention, the transmitter may further comprise: a mapping block, for providing the data stream by mapping log₂M information bits of an incoming data stream to the mapping block.

According to a fifth aspect of the invention, an electronic device utilizing a multichannel transmission, comprises: a transmitter, for providing a multipath signal, the transmitter containing: a mapping block, for providing data stream by mapping log₂M information bits of an incoming data stream to the mapping block; and a linear precoder, for performing precoding of the data stream, wherein the precoder is described by a preceding matrix W=U [symbol] I, wherein U is a k×n matrix given by

$$U = [ \begin{matrix}{a}_{11} & {a}_{12} & … & {a}_{1 k} \\ {a}_{11} & {a}_{22} & … & {a}_{2 k} \\ ⋮ & ⋮ & ⋮ & ⋮ \\ {a}_{n 1} & {a}_{n 2} & … & {a}_{nk}\end{matrix} ] , \qquad ( C1 )$$

or U is a further matrix generated by permuting rows or columns of the matrix given by Equation C1 or by multiplying the rows or the columns of the matrix given by Equation C1 by non-zero real or complex numbers, wherein k and n are larger than 2, each element of all elements a₁₁, a₁₂, . . . , aₙₖ of the matrix U is a real or a complex number, [symbol] is a Kronecker product, and I is an m×m identity matrix with m≧1, wherein at least two of the elements a₁₁, a₁₂, . . . , aₙₖ or at least two of elements of the further matrix have different amplitudes, and U and the further matrix are not Vandermonde matrices, wherein the precoded data stream is further used for generating the multipath signal by the transmitter.

According to a fifth aspect of the invention, an integrated circuit capable of linearly precoding a data stream utilizing a multichannel transmission, comprises: a mapping block, for providing a data stream; and a linear precoder, for performing precoding of the data stream, wherein the precoder is described by a precoding matrix W=U [symbol] I, wherein U is a k×n matrix given by

$$U = [ \begin{matrix}{a}_{11} & {a}_{12} & … & {a}_{1 k} \\ {a}_{11} & {a}_{22} & … & {a}_{2 k} \\ ⋮ & ⋮ & ⋮ & ⋮ \\ {a}_{n 1} & {a}_{n 2} & … & {a}_{nk}\end{matrix} ] , \qquad ( C1 )$$

or U is a further matrix generated by permuting rows or columns of the matrix given by Equation C1 or by multiplying the rows or the columns of the matrix given by Equation C1 by non-zero real or complex numbers, wherein k and n are larger than 2, each element of all elements a₁₁, a₁₂, . . . , aₙₖ of the matrix U is a real or a complex number, [symbol] is a Kronecker product, and I is an m×m identity matrix with m≧1, wherein at least two of the elements a₁₁, a₁₂, . . . , aₙₖ or at least two of elements of the further matrix have different amplitudes, and U and the further matrix are not Vandermonde matrices.

### BRIEF DESCRIPTION OF THE DRAWINGS

For a better understanding of the nature and objectives of the present invention, reference is made to the following detailed description taken in conjunction with the following drawings, in which:

FIG. 1 is a block diagram of a multichannel transmission with a precoder using an OFDM system;

FIG. 2 is a graph demonstrating performance comparison of different precoders in a 16-QAM modulated MB-OFDM UWB system; and

### BEST MODE FOR CARRYING OUT THE INVENTION

The present invention provides a new precoding method in a transmitter utilizing a multichannel transmission, e.g., using a precoder in an M-QAM (M>4) modulated OFDM system. The precoding described by the present invention can be applied to a variety of systems based on OFDM, CDMA, etc. Moreover, it can be applied to a variety of modulation formats including (but not limited to) QAM, PAM, BPSK, QPSK, etc. Furthermore, the transmitter utilizing the linear preceding can be a part of an electronic device, such as an electronic communication device, a portable electronic device, a wireless device, a mobile terminal, a mobile phone, etc.

The performance of high-rate and high-diversity (HDHR) schemes may be improved by constellation rotations via linear precoding of transmitted data, as known from the prior art. However, often the precoders are designed only to guarantee a fall diversity (or a certain diversity order). The coding gain associated with precoding performance affects the overall system performance and should be also optimized along with high-rate and high diversity system parameters. That is a prime object of the present invention.

The present invention describes a new precoding method that is suitable for use, e.g., in an M-QAM modulated MB-OFDM UWB system especially while targeting for high data rates (above 480 Mbps).

This may involve transmitting 16-QAM in place of 4-QAM symbols. The method could be adopted also for some future wireless LANs (local area networks), to future evolutions of 3G and for 4G systems.

According to an embodiment of the present invention, a linear precoder performing precoding of incoming data stream is described by a precoding matrix:

W=U [symbol] I (4),

wherein U is a k×n matrix given by

$$U = [ \begin{matrix}{a}_{11} & {a}_{12} & … & {a}_{1 k} \\ {a}_{11} & {a}_{22} & … & {a}_{2 k} \\ ⋮ & ⋮ & ⋮ & ⋮ \\ {a}_{n 1} & {a}_{n 2} & … & {a}_{nk}\end{matrix} ] , \qquad ( 5 )$$

wherein k and n are larger than 2, each element a₁₁, a₁₂, . . . , aₙₖ of said matrix U is a real number or a complex number, [symbol] is a Kronecker product, and I is an m×m identity matrix with m≧1 (for m=1, W=U), wherein at least two of said elements a₁₁, a₁₂, . . . , aₙₖ have different amplitudes, and U is not a Vandermonde matrix. Normalization in Equation 4 is omitted for simplicity. The complex numbers can have preferably vanishing real components.

Moreover, according to an embodiment of the present invention, the matrix U can be a further matrix generated:

a) by permuting rows or columns of the matrix given by Equation 5 or

b) by multiplying the rows or the columns of the matrix given by Equation 5 by non-zero real or complex numbers, such that, again, at least two of the elements of the further matrix have different amplitudes, and the further matrix is not the Vandermonde matrix.

Furthermore, according to an embodiment of the present invention, the data stream provided to the linear precoder can be generated by mapping M constellation points (constellation alphabet) using, e.g., a quadrature amplitude modulation (QAM) format, wherein M>4. Then a constellation point of the data stream is described by log₂M bits generated by the mapping, i.e., the mapping block takes log₂M information bits of the incoming data stream as an input and maps them to a constellation point.

The important practical case (e.g., for 16-QAM modulation) is when the matrix U described by Equation 5 is a square matrix, i.e., k=n.

According to embodiments of the present invention, the matrix U described by Equation 5 can be given by the following matrices with k=n=4:

$$\begin{matrix}U = ( {U}_{1} ⊗ {U}_{2} ) = [ \begin{matrix}1 & 4 & 1 & 4 \\ 4 & - 1 & 4 & - 1 \\ 1 & 4 & - 1 & - 4 \\ 4 & - 1 & - 4 & 1\end{matrix} ] , \\ wherein {U}_{1} = [ \begin{matrix}1 & 1 \\ 1 & - 1\end{matrix} ] and {U}_{2} = [ \begin{matrix}1 & 4 \\ 4 & - 1\end{matrix} ] ; & ( 6 ) \\ U = ( {U}_{1} ⊗ {U}_{2} ) = [ \begin{matrix}1 & 2 & 1 & 2 \\ 2 & - 1 & 2 & - 1 \\ 1 & 2 & - 1 & - 2 \\ 2 & - 1 & - 2 & 1\end{matrix} ] \\ wherein {U}_{1} = [ \begin{matrix}1 & 1 \\ 1 & - 1\end{matrix} ] and {U}_{2} = [ \begin{matrix}1 & 2 \\ 2 & - 1\end{matrix} ] ; & ( 7 ) \\ U = ( {U}_{1} ⊗ {U}_{2} ) = [ \begin{matrix}1 & - 2 & 2 j & - 4 j \\ 2 & 1 & 4 j & 2 j \\ 2 j & - 4 j & - 1 & 2 \\ 4 j & 2 j & - 2 & - 1\end{matrix} ] \\ wherein {U}_{1} = [ \begin{matrix}1 & 2 j \\ 2 j & - 1\end{matrix} ] and {U}_{2} = [ \begin{matrix}1 & - 2 \\ 2 & 1\end{matrix} ] ; or & ( 8 ) \\ U = ( {U}_{1} ⊗ {U}_{2} ) = [ \begin{matrix}1 & - 2 & - 2 & 4 \\ 2 & - 1 & - 4 & - 2 \\ 2 & - 4 & - 1 & 2 \\ 4 & 2 & - 2 & 1\end{matrix} ] \\ wherein {U}_{1} = [ \begin{matrix}1 & - 2 \\ 2 & - 1\end{matrix} ] and {U}_{2} = [ \begin{matrix}1 & - 2 \\ 2 & 1\end{matrix} ] . & ( 9 )\end{matrix}$$

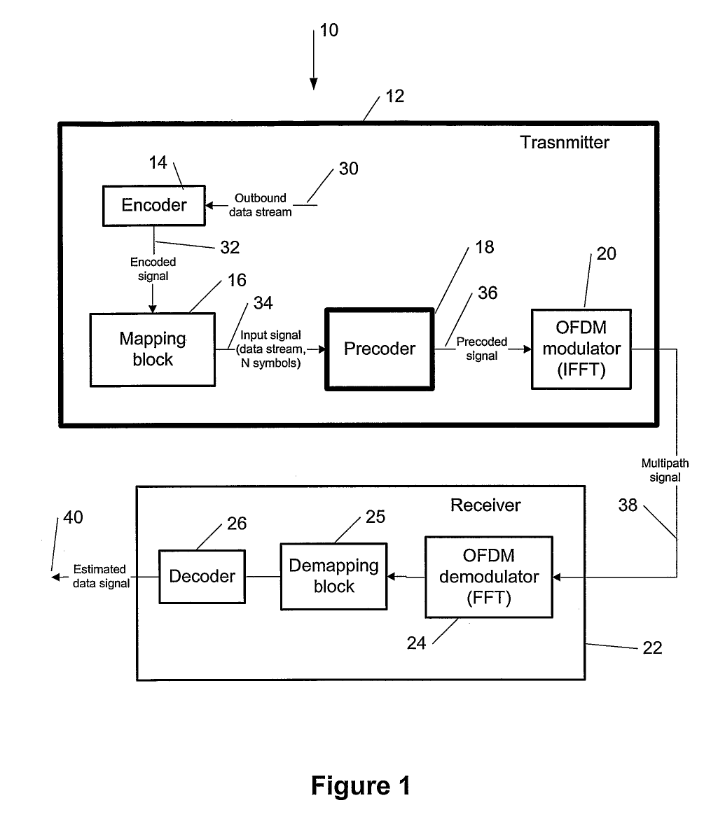

FIG. 1 shows one example among others of a block diagram of multichannel transmission with a linear precoder 18 contained in a transmitter 12 of an OFDM system 10 comprising the transmitter 12 and a receiver 22, according to an embodiment of the present invention.

On a transmitter 12 side, an outbound data stream 30 is encoded by an encoder 14 and then provided (an encoded signal 32) to a mapping block 16 which maps the encoded signal 32 into a data stream 34 using, for example, M constellation points and the quadrature amplitude modulation (QAM) format with M>4 (e.g., 16-QAM), according to the embodiment of the present invention as described above. After mapping, the linear precoder 18 processes successive blocks of the mapped data (the data stream 34) and generates the precoded signal 36 (using the precoder matrix given by Equations 4-9) which is then modulated using the OFDM modulator 20 performing an Inverse Fast Fourier Transform (IFFT) for generating a multipath signal 38. The precoder 18 can be implemented by hardware, software or both. Furthermore, the linear precoder 18, the mapping block 16 and other blocks of the transmitter 12 can be integrated on one chip (integrated circuit). The signal processing on the receiver 22 side is conventional which includes demodulation by an OFDM demodulator 24, demapping by a demapping block 25 and decoding by a decoder 26.

According to an embodiment of the present invention, a size of the identity matrix I for the example of the OFDM system shown in FIG. 1 can be determined as a ratio of a size of the Inverse Fast Fourier Transform (IFFT) divided by k (for the case k=n, i.e. Matrix U is a square matrix)). For instance if the size of the IFFT is 8 and K=4, then the size (m) of the identity matrix I is m=8/4=2. Then, if the matrix U is described, e.g., by the Equation 6, the precoding matrix W is given, using Equation 4, by

$$W = [ \begin{matrix}1 \; 0 & 4 \; 0 & 1 \; 0 & 4 \; 0 \\ 0 \; 1 & 0 \; 4 & 0 \; 1 & 0 \; 4 \\ 4 \; 0 & - 1 \; 0 & 4 \; 0 & - 1 \; 0 \\ 0 \; 4 & 0 - 1 & 0 \; 4 & 0 - 1 \\ 1 \; 0 & 4 \; 0 & - 1 \; 0 & - 4 \; 0 \\ 0 \; 1 & 0 \; 4 & 0 - 1 & 0 - 4 \\ 4 \; 0 & - 1 \; 0 & - 4 \; 0 & 1 \; 0 \\ 0 \; 4 & 0 - 1 & 0 - 4 & 0 \; 1\end{matrix} ] . \qquad ( 10 )$$

The total precoded OFDM matrix (including blocks 18 and 20) can be expressed as

F=FₐW (11),

wherein W is given by Equation 4 and Fₐ is a d-dimensional (d>1) IFFT matrix of the block 20. In the prior art systems, the precoding matrix of Equation 4 can be described (see A. Hottinen and O. Tirkkonen, “Precoder Designs for High Rate Space-Time Block Codes,” Conference on Information Sciences and Systems, Princeton University, Mar. 17-19, 2004, referred here as Hottinen et al.) as

$$W = U ⊗ I = [ \begin{matrix}μ & υ \\ - {υ}^{*} & {μ}^{*}\end{matrix} ] ⊗ I \qquad ( 12 )$$

Matrix U in Equation 12 has only two non-zero coefficients in each row/column, in order to minimize PAR (peak-to-average ratio) increase and to enable the use of simple receivers. In the aforementioned publication, the precoding matrix is used in a multi-antenna transmitter system.

According to another embodiment of the present invention, precoding in the UWB system can be performed as follows. The parameter values of the matrix U are (μ, υ)=(\sqrt{0.8}, \sqrt{0.2}) in the current UWB system, when 4QAM input alphabets are used. Then, given an input vector with QPSK coordinate constellations, each output coordinate of the precoder (utilizing 2 subcarriers) has 16-QAM constellation [2, 1, 4].

With a 16-QAM input, the precoding matrix defined for the 4QAM modulation is no longer optimal and very limited gains can be achieved. Any precoding matrix that mixes the symbols between only two subcarriers seems to give insufficient performance gains. However, significant gains are achievable with a precoder that mixes four or more subcarriers, or other orthogonal channel resources. These gains are sufficiently high in order to provide substantial performance improvement for, e.g., MB-OFDM 1 Gbps UWB links.

According to an embodiment of the present invention, the 2×2 precoder defined by the 4-QAM input is used as a constituent precoder for the 16-QAM. This allows a system designer to use the same or similar transmitter building blocks also in the 16QAM case. Indeed, if the matrix U describes the current MB-OFDM UWB linear precoder, one possible extension can be described as follows

$$[ \begin{matrix}{y}_{1} \\ {y}_{2}\end{matrix} ] = [ \begin{matrix}{F}_{1} {Ux}_{1} \\ {F}_{2} {Ux}_{2}\end{matrix} ] + 2 j [ \begin{matrix}{F}_{1} {Ux}_{2} \\ {F}_{2} {Ux}_{1}\end{matrix} ] , \qquad ( 13 )$$

wherein vector y₁ is transmitted using subcarriers f₁ and f₂ (specified by the columns of matrix F₁), and vector y₂ is transmitted using subcarriers f₃ and f₄ (specified by the matrix F₂) and x₁ and x₂ are corresponding precoder inputs. Normalization is omitted here, for simplicity. Thus, the signal is spread across four subcarriers which are in general arbitrary subcarrier frequencies, but preferably equidistant from each other. Thus, the subcarrier indexes 1, 2, 3 and 4 above are denoted here to convey that 4 different subcarriers are used, while in practice the actual indexes may be different.

The current UWB specification is captured by the first term of the sum of Equation 13 and this is used with the 4-QAM input. With the 16-QAM input this embodiment adds the second term of the sum to the transmitted signal but using the same matrix U as it is used in the current specification. Thus, the concept with the 16-QAM input can be implemented essentially with the same transmission resources. Abstracting from the subcarrier part, the precoder described above can be modeled by the precoding matrix as

W=(U₁ [symbol] U₂) [symbol] I (14),

wherein, I is the m×m identity matrix with m≧1 as described above (see Equation 4) and U=(U₁ [symbol] U₂), which brings Equation 14 to the format of Equation 4. Limitations for matrices U₁ and U₂ are the same as for the matrix U described by the Equation 5, i.e., at least two of elements of the matrices U₁ and U₂ have different amplitudes, and matrices U₁ and U₂ are not the Vandermonde matrices.

It is noted that for the purpose of the present invention subcarriers f₁, f₂, f₃, and f₄ discussed above can be interpreted in a broader sense as orthogonal waveforms defined based on a predetermined criterion using, e.g., Inverse Fast Fourier Transform (IFFT) matrix columns, different time instances, different orthogonal spreading codes or different wavelets (frequencies). Thus, the data stream for precoding can be generated by mapping bits of the incoming data stream using multidimensional constellation in combination with multiple orthogonal waveforms.

It is further noticed that if a rectangular precoding matrix of Equation 4 is used with k>n, the input symbols need to be transmitted using substantially different orthogonal transmission resources, by using altogether k subcarriers (or orthogonal waveforms discussed above), e.g., k time slots, k spreading codes or a combination thereof. For example, if a combination of subcarriers can be given by k=k1+k2, with k1 a number of orthogonal transmission resources of type one (e.g., time slots) and k2 is a number of orthogonal transmission resources of type two (e.g., spreading codes).

Therefore, according to the embodiment of the present invention as described above, a linear precoder can be built using Kronecker product of two similar constituent precoders. When used in the MB-OFDM UWB system, the described precoding method can utilize existing precoding methods recursively, and thus it is rather simple to implement in the existing transmitter.

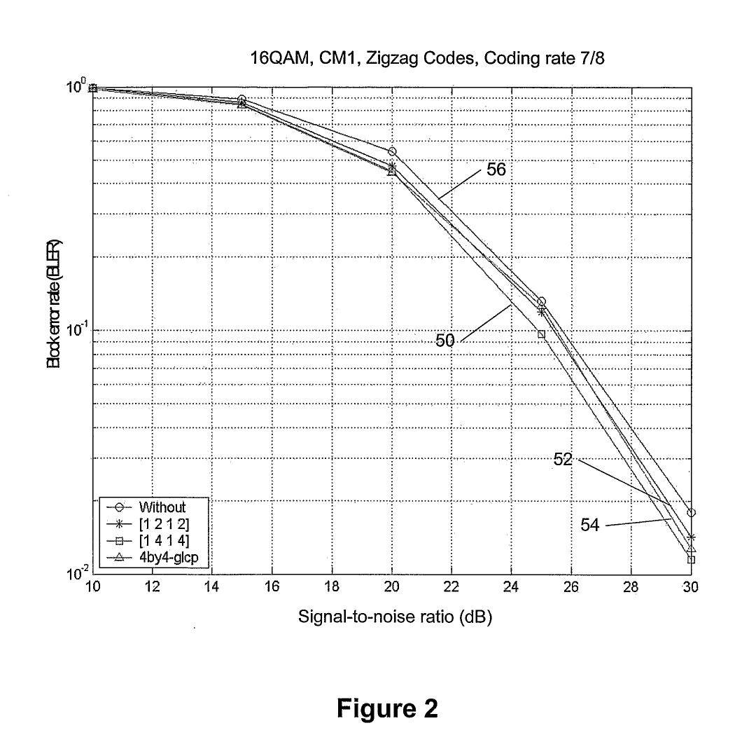

FIG. 2 shows an example among many others of a graph demonstrating performance comparison of different precoders by simulation. The simulation presents a block error rate as a function of the signal-to-noise ratio and it is performed for an MB-OFDM UWB system, in CM1 (channel model 1) environment utilizing the IFFT with a size of 128, using 16-QAM modulation and Zigzag codes with the coding rate of ⅞. The graph shows a curve 56 without precoding, a curve 54 per the prior art of Liu et al., a curve 52 for the matrix U described by Equation 7 and a curve 50 for the matrix U described by the Equation 6. As seen from FIG. 2, the best gain performance has the curve 50 generated according to the present invention.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. A method comprising:
providing a data stream to a precoder; and
performing precoding of said data stream by said precoder for a multichannel transmission, wherein the precoder is described by a precoding matrix
W=U [symbol] I,
wherein U is a k×n matrix given by
$$U = [ \begin{matrix}{a}_{11} & {a}_{12} & … & {a}_{1 k} \\ {a}_{11} & {a}_{22} & … & {a}_{2 k} \\ ⋮ & ⋮ & ⋮ & ⋮ \\ {a}_{n 1} & {a}_{n 2} & … & {a}_{nk}\end{matrix} ] , \qquad ( C1 )$$
or U is a further matrix generated by
permuting rows or columns of the matrix given by Equation C1 or by multiplying said rows or said columns of the matrix given by Equation C1 by non-zero real or complex numbers,
wherein k and n are larger than 2, each element of all elements a₁₁, a₁₂, . . . , aₙₖ of said matrix U is a real or a complex number, [symbol] is a Kronecker product, and I is an m×m identity matrix with m≧1, wherein
at least two of said elements a₁₁, a₁₂, . . . , aₙₖ or at least two of elements of said further matrix have different amplitudes, and U and said further matrix are not Vandermonde matrices.

2. The method of claim 1, wherein n=k and said matrix U is a square matrix.

3. The method of claim 1, wherein m=1 and W=U.

4. The method of claim 1, wherein k=n=4 and
$$U = ( {U}_{1} ⊗ {U}_{2} ) = [ \begin{matrix}1 & 4 & 1 & 4 \\ 4 & - 1 & 4 & - 1 \\ 1 & 4 & - 1 & - 4 \\ 4 & - 1 & - 4 & 1\end{matrix} ] , \\ wherein {U}_{1} = [ \begin{matrix}1 & 1 \\ 1 & - 1\end{matrix} ] and {U}_{2} = [ \begin{matrix}1 & 4 \\ 4 & - 1\end{matrix} ] .$$

5. The method of claim 1, wherein k=n=4 and
$$U = ( {U}_{1} ⊗ {U}_{2} ) = [ \begin{matrix}1 & 2 & 1 & 2 \\ 2 & - 1 & 2 & - 1 \\ 1 & 2 & - 1 & - 2 \\ 2 & - 1 & - 2 & 1\end{matrix} ] , \\ wherein {U}_{1} = [ \begin{matrix}1 & 1 \\ 1 & - 1\end{matrix} ] and {U}_{2} = [ \begin{matrix}1 & 2 \\ 2 & - 1\end{matrix} ] .$$

6. The method of claim 1, wherein k=n=4 and
$$U = ( {U}_{1} ⊗ {U}_{2} ) = [ \begin{matrix}1 & - 2 & 2 j & - 4 j \\ 2 & 1 & 4 j & 2 j \\ 2 j & - 4 j & - 1 & 2 \\ 4 j & 2 j & - 2 & - 1\end{matrix} ] , \\ wherein {U}_{1} = [ \begin{matrix}1 & 2 j \\ 2 j & - 1\end{matrix} ] and {U}_{2} = [ \begin{matrix}1 & - 2 \\ 2 & 1\end{matrix} ] .$$

7. The method of claim 1, wherein k=n=4 and
$$U = ( {U}_{1} ⊗ {U}_{2} ) = [ \begin{matrix}1 & - 2 & - 2 & 4 \\ 2 & - 1 & - 4 & - 2 \\ 2 & - 4 & - 1 & 2 \\ 4 & 2 & - 2 & 1\end{matrix} ] , \\ wherein {U}_{1} = [ \begin{matrix}1 & - 2 \\ 2 & - 1\end{matrix} ] and {U}_{2} = [ \begin{matrix}1 & - 2 \\ 2 & 1\end{matrix} ] .$$

8. The method of claim 1, wherein said data stream is generated by mapping information bits of an incoming data stream using a multidimensional constellation with one waveform or using said multidimensional constellation in combination with multiple orthogonal waveforms.

9. The method of claim 8, wherein said orthogonal waveforms are defined using a predetermined criterion for Inverse Fast Fourier Transform matrix columns, different time instances, different orthogonal spreading codes or different wavelets.

10. The method of claim 1, wherein said data stream is generated by mapping M constellation points using a quadrature amplitude modulation format, wherein M>4.

11. The method of claim 10, wherein a constellation point of said data stream is generated by mapping log₂M information bits of an incoming data stream.

12. The method of claim 1, wherein said multichannel transmission is supported by an orthogonal frequency-division multiplexing system.

13. The method of claim 12, wherein m is equal to a size of an Inverse Fast Fourier Transform divided by k.

14. A computer program product comprising -a computer readable storage structure embodying computer program code thereon for execution by a computer processor with said computer program code, wherein said computer program code comprises instructions for performing the method of claim 1.

15. An apparatus, comprising:
a linear precoder, configured to perform precoding of a data stream for a multichannel transmission, wherein the precoder is described by a precoding matrix
W=U [symbol] I,
wherein U is a k×n matrix given by
$$U = [ \begin{matrix}{a}_{11} & {a}_{12} & … & {a}_{1 k} \\ {a}_{11} & {a}_{22} & … & {a}_{2 k} \\ ⋮ & ⋮ & ⋮ & ⋮ \\ {a}_{n 1} & {a}_{n 2} & … & {a}_{nk}\end{matrix} ] , \qquad ( C1 )$$
or U is a further matrix generated by
permuting rows or columns of the matrix given by Equation C1 or
by multiplying said rows or said columns of the matrix given by Equation C1 by non-zero real or complex numbers,
wherein k and n are larger than 2, each element of all elements a₁₁, a₁₂, . . . , aₙₖ of said matrix U is a real or a complex number, [symbol] is a Kronecker product, and I is an m×m identity matrix with m≧1, wherein
at least two of said elements a₁₁, a₁₂, . . . , aₙₖ or at least two of elements of said further matrix have different amplitudes, and U and said further matrix are not Vandermonde matrices.

16. The apparatus of claim 15, wherein n=k and said matrix U is a square matrix.

17. The apparatus of claim 15, wherein m=1 and W=U.

18. The apparatus of claim 15, wherein k=n=4 and
$$U = ( {U}_{1} ⊗ {U}_{2} ) = [ \begin{matrix}1 & 4 & 1 & 4 \\ 4 & - 1 & 4 & - 1 \\ 1 & 4 & - 1 & - 4 \\ 4 & - 1 & - 4 & 1\end{matrix} ] , \\ wherein {U}_{1} = [ \begin{matrix}1 & 1 \\ 1 & - 1\end{matrix} ] and {U}_{2} = [ \begin{matrix}1 & 4 \\ 4 & - 1\end{matrix} ] .$$

19. The apparatus of claim 15, wherein k=n=4 and
$$U = ( {U}_{1} ⊗ {U}_{2} ) = [ \begin{matrix}1 & 2 & 1 & 2 \\ 2 & - 1 & 2 & - 1 \\ 1 & 2 & - 1 & - 2 \\ 2 & - 1 & - 2 & 1\end{matrix} ] , \\ wherein {U}_{1} = [ \begin{matrix}1 & 1 \\ 1 & - 1\end{matrix} ] and {U}_{2} = [ \begin{matrix}1 & 2 \\ 2 & - 1\end{matrix} ] .$$

20. The apparatus of claim 15, wherein k=n=4 and
$$U = ( {U}_{1} ⊗ {U}_{2} ) = [ \begin{matrix}1 & - 2 & 2 j & - 4 j \\ 2 & 1 & 4 j & 2 j \\ 2 j & - 4 j & - 1 & 2 \\ 4 j & 2 j & - 2 & - 1\end{matrix} ] , \\ wherein {U}_{1} = [ \begin{matrix}1 & 2 j \\ 2 j & - 1\end{matrix} ] and {U}_{2} = [ \begin{matrix}1 & - 2 \\ 2 & 1\end{matrix} ] .$$

21. The apparatus of claim 15, wherein k=n=4 and
$$U = ( {U}_{1} ⊗ {U}_{2} ) = [ \begin{matrix}1 & - 2 & - 2 & 4 \\ 2 & - 1 & - 4 & - 2 \\ 2 & - 4 & - 1 & 2 \\ 4 & 2 & - 2 & 1\end{matrix} ] , \\ wherein {U}_{1} = [ \begin{matrix}1 & - 2 \\ 2 & - 1\end{matrix} ] and {U}_{2} = [ \begin{matrix}1 & - 2 \\ 2 & 1\end{matrix} ] .$$

22. The apparatus of claim 32, wherein the mapping block is configured to venerate said data stream by mapping information bits of an incoming data stream using a multidimensional constellation with one waveform or using said multidimensional constellation in combination with multiple orthogonal waveforms.

23. The apparatus of claim 22, wherein the mapping block is configured to define said orthogonal waveforms are defined using a predetermined criterion for Inverse Fast Fourier Transform matrix columns, different time instances, different orthogonal spreading codes or different wavelets.

24. The apparatus of claim 32, wherein the mapping block is configured to generate said data stream by mapping M constellation points using a quadrature amplitude modulation format, wherein M>4.

25. The apparatus of claim 24, wherein the mapping block is configured to generate a constellation point of said data stream by mapping log₂M information bits of an incoming data stream.

26. The apparatus of claim 15, wherein said multichannel transmission is supported by an orthogonal frequency-division multiplexing system and said transmitter comprises an OFDM modulator for performing an Inverse Fast Fourier Transform.

27. The apparatus of claim 26, wherein m is equal to a size of the Inverse Fast Fourier Transform divided by k.

28. A system comprising:
a transmitter, configured to provide a multipath signal for a multichannel transmission; and
a receiver, responsive to said multipath signal, configured to generate an estimated data signal, wherein said transmitter comprises:
a linear precoder, configured to perform precoding of a data stream for said multichannel transmission, wherein the precoder is described by a precoding matrix
W=U [symbol] I,
wherein U is a k×n matrix given by
$$U = [ \begin{matrix}{a}_{11} & {a}_{12} & … & {a}_{1 k} \\ {a}_{11} & {a}_{22} & … & {a}_{2 k} \\ ⋮ & ⋮ & ⋮ & ⋮ \\ {a}_{n 1} & {a}_{n 2} & … & {a}_{nk}\end{matrix} ] , \qquad ( C1 )$$
or U is a further matrix generated by
permuting rows or columns of the matrix given by Equation C1 or
by multiplying said rows or said columns of the matrix given by Equation C1 by non-zero real or complex numbers,
wherein k and n are larger than 2, each element of all elements a₁₁, a₁₂, . . . , aₙₖ of said matrix U is a real or a complex number, [symbol] is a Kronecker product, and I is an m×m identity matrix with m≧1, wherein
at least two of said elements a₁₁, a₁₂, . . . , aₙₖ or at least two of elements of said further matrix have different amplitudes, and U and said further matrix are not Vandermonde matrices,
wherein said precoded data stream is further used for generating said multipath signal by said transmitter.

29. The system of claim 28, wherein the transmitter further comprises:
a mapping block, configured to provide said data stream by mapping log₂M information bits of an incoming data stream.

30. (canceled)

31. (canceled)

32. The apparatus of claim 15, further comprising a mapping block configured to provide said data stream.

33. The apparatus of claim 15, wherein said apparatus is a transmitter configured to provide a multipath signal for said multichannel transmission.

34. The apparatus of claim 33, wherein said transmitter is a part of an electronic device utilizing said multichannel transmission, said electronic device being an electronic communication device, a portable electronic device, a wireless device, a mobile terminal or a mobile phone.

35. The apparatus of claim 15, wherein an integrated circuit comprises all or selected modules of said apparatus.
